(19) United States
(12) Patent Application Publication
(10) Pub. No.: US 2019/0357498 A1
(43) Pub. Date: Nov. 28, 2019

(54) PET CHEW TOY

(71) Applicant: Cosmic Pet LLC, Wichita, KS (US)

(72) Inventor: Caitlin A. Goetzel, Oakland, CA (US)

(21) Appl. No.: 16/423,989

(22) Filed: May 28, 2019

Related U.S. Application Data
(60) Provisional application No. 62/676,606, filed on May 25, 2018.

(51) Int. Cl. A01K 15/02

(52) U.S. Cl. CPC A01K 15/026; B29C 45/16

(57) ABSTRACT

A pet chew toy may include a core comprising a mixture of wood and a thermoplastic elastomer and a layer of a thermoplastic elastomer partially covering the core.

### BACKGROUND

Pet chew toys are often given to pets, such as dogs, to prevent boredom and curb destructive chewing. Such pet chew toys may additionally clean the pet's teeth.

### DETAILED DESCRIPTION OF EXAMPLES

Disclosed herein are example pet chew toys that have a core formed from a thermoplastic elastomer (sometimes referred to as a thermoplastic rubber) and small wood particles. The wood particles or material provide flavor to the chew toy. Unfortunately, the core may be subject to premature breakdown or breakage. The disclosed pet chew toys additionally comprise a coating or layer of a thermoplastic elastomer about the core. The layer enhances the life of the chew toy. More specifically, the layer serves as a spine or encasement partially about the core that strengthens the core, allowing the core and the pet chew toy itself to have more irregular, potentially aesthetic, shapes with projecting portions and narrow portions that without the layer, might provide weaker points subjecting the chew toy to premature breakage.

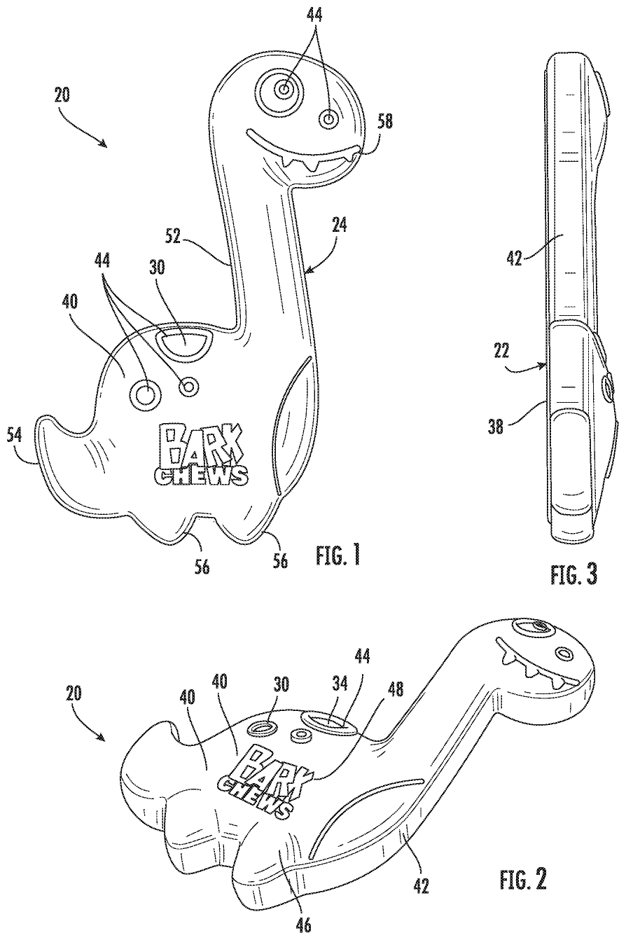

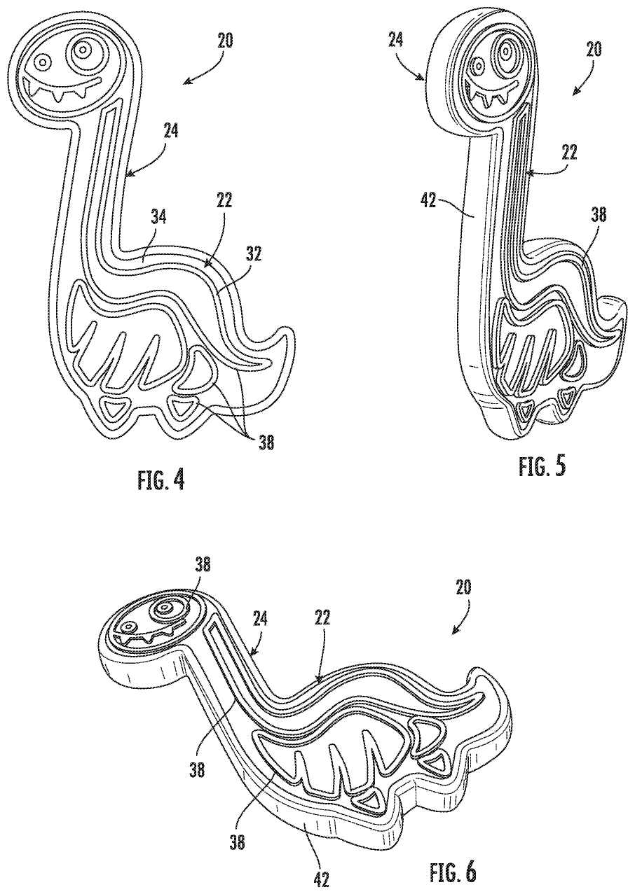

FIGS. 1-6 are various views of an example pet chew toy 20. Pet chew toy 20 provides enhanced texture and flavor while, at the same time, being robust, less likely to prematurely break apart or breakdown. Pet chew toy 20 comprises core 22 and outer layer 24. Core 22 comprises a molding form from a mixture of a thermoplastic elastomer, sometimes referred to as a thermoplastic rubber, and ground would material or particles. The ground would material or particles are mixed and held together by the thermoplastic elastomer. In one implementation, the mixture forming core 22 comprises at least 20% would material and at least 70% of the thermoplastic elastomer. The wood material is ground or cut such that a particle size of at least 0.1 mm and no greater than 2 mm. In one implementation, the wood comprises a poplar. In other implementations, the wood may comprise other types of wood.

As shown by FIGS. 4-6, core 22 is generally planar, having a lower surface or face 30, an upper surface or face 32 and side edges 34. Faces 30 and 32 extend opposite to one another, facing in opposite directions decided just 34 interconnecting such opposite faces. In the example illustrated, upper face 32 comprise a three-dimensional image. In the example illustrated, face 32 comprises an arrangement of projecting ribs 38 that rise above the rest of core 22 or its main body to provide core 22 the three-dimensional image. Such ribs 32 simultaneously provide upper face 32 with texture to provide enhanced oral experience for the pet chewing toy 20.

Layer 24 comprise a layer of a thermoplastic elastomer, a thermoplastic rubber, which covers or coats lower face 30 and side edges 34 of core 22, leaving the majority, if not all, of upper face 32 exposed. In one implementation, layer 24 is co-molded over in about lower face 30 and side edges 34. In the example illustrated, layer 24 comprises a floor 40 and sidewalls 42 which form a pan that receives core 22. Floor 40 and sidewalls 42 cooperate to retain the shape of core 22 by inhibiting breaking of core 22 during chewing. Floor 240 and sidewalls 42 facilitate the shaping of core 22 into more complex, aesthetically pleasing shapes having narrower portions and projecting portions, with a reduced risk that such narrower portions or projecting portions may otherwise provide points of structural weakness at which core 22 would otherwise separator break apart during chewing. In one implementation, layer 22 comprises a thermoplastic elastomer or thermoplastic rubber such as thermoplastic rubber (TPR), thermoplastic vinyl (TPV), thermoplastic polyurethane (TPU), polyester poly pro (YPE), poly propylene (PP), Acrylonitrile butadiene styrene (ABS), polyamide nylon (PA), polyethylene (PE), polystyrene (PS) or other thermoplastic rubber-like materials/elastomers.

As shown by such figures, sidewalls 42 extend along at least a majority of a height of side edges 34 of core 22. In the example illustrated, sidewalls 42 extend along an entire height of side edges 34, sidewalls 42 having a height substantially equal to the thickness of core 22. As a result, sidewalls 42 better retain the shape of core 22, inhibiting breaking a fracturing of core 22 along its periphery.

In the example illustrated, ribs 38 project above and beyond the top edge of sidewalls 42. Because ribs 38 project above and beyond the top edge of sidewalls 42, the texture provided by ribs 38 is prominent and is not off you skated by the presence of sidewalls 42. This texture provides an enhanced chewing experience for the pet. Because layer 24 does not completely encompass core 22, but instead leaves substantially the entire upper face 32 of core 22 exposed, core 22 is able to release a greater degree of flavor for the pet chewing toy 20.

As shown by FIG. 1, floor 40 of layer 24 comprises a plurality of spaced openings 44. Such openings 44 expose portions of lower surface 30 of core 22. Such exposure of core 22 facilitates the release of flavor through layer 24 for enhanced chewing experience for the pet. Such openings further provide aesthetic features for the chew toy. At the same time, such openings are of a limited size so as to not render core 22 subject to breakage during chewing. In one implementation, such openings each have an area of no greater than 90% of the front face area. In other implementations, such openings 44 may be omitted.

As further shown by FIGS. 1 and 2, floor 40 has an outer exterior surface 46 provided with a three-dimensional graphic or image. The exterior surface 46 are provided with multiple raised portions or ribs 48 which provide the exterior lower portion of chew toy 20 with additional texture for chewing. In one implementation, a three-dimensional image may be linked or associated with the three-dimensional image provided an upper face 32 of core 22 as well as the overall asymmetric shape of pet chew toy 20 provided by the shape or outline of sidewalls 42. In the example illustrated, the outer sidewalls 42 have the shape of a dinosaur, such as a brontosaurus. The three-dimensional images provided on faces 32 and 46 provide additional detail of the dinosaur. In other implementations, one or both of faces 32 and 46 may omit the three-dimensional raised images or graphics.

In the example illustrated, core 22 has a thickness of at least 50 mm and no greater than 70 mm. At the same time, layer 24 has a thickness of at least 5 mm and no greater than 10 mm. In other implementations, such dimensions may be varied.

Overall, pet chew toy 20 provides enhanced flavor through the exposure of faced 32 as well as portions of lower face 30 through openings 44. Pet chew toy 20 provides an enhanced chewing experience by providing enhanced texture the use of ribs 38 on upper face 32 of core 22 and through the use of ribs 48 on face 46 of floor 40 of layer 24. Pet chew toy 20 provides further enhanced texture and chewing shapes by providing various narrow portions, such as neck portion 52 and various projecting portions, such as projecting portions 54, 56 and 58 (corresponding to the tail, legs and head. These asymmetric or irregular shape and enhanced chewing experience. At the same time, such narrow portions and projections do not render core 22 subject to premature breaking or degradation during chewing due to the provision of layer 24. Layer 24 maintains the shape of core 22, even when core 22 has an irregular shape which might otherwise provide structurally weaker regions where breakage of core 22 would more likely occur.

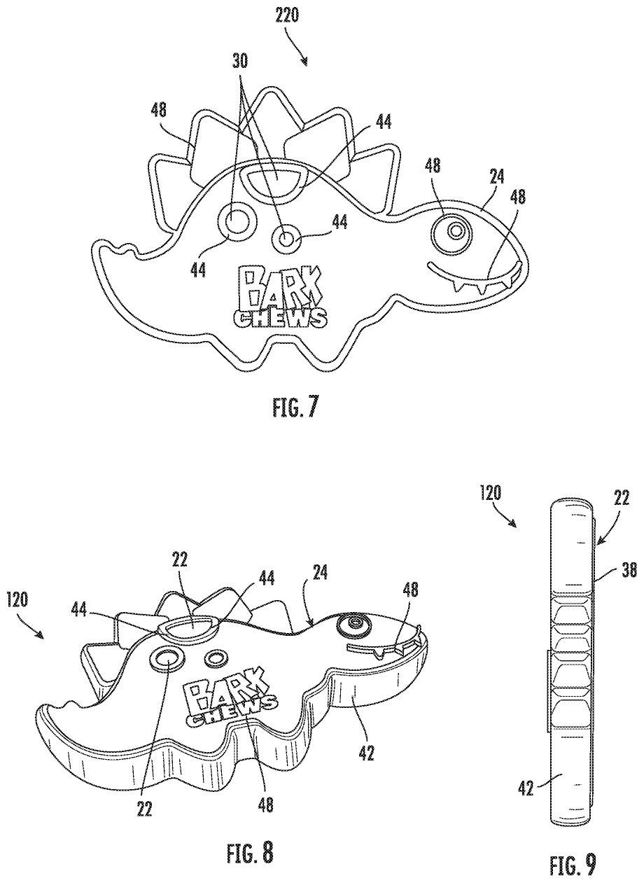

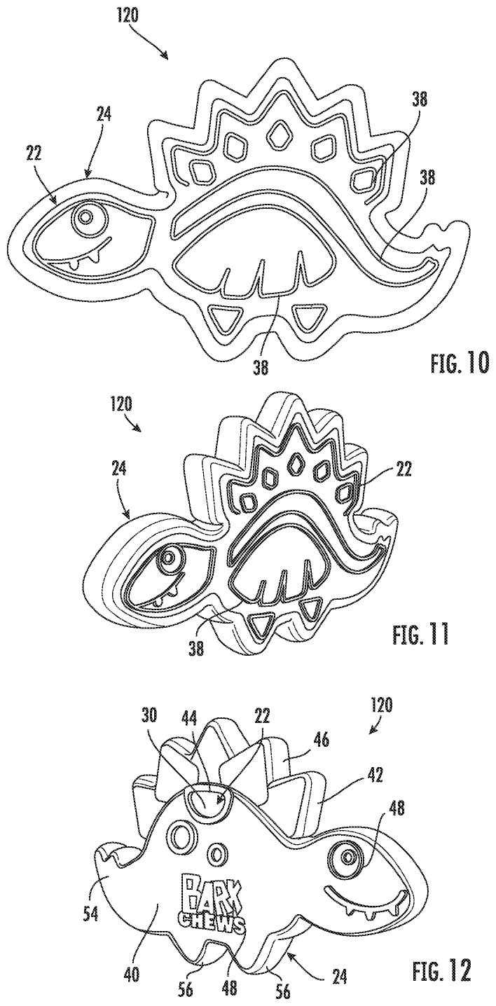

FIGS. 7-12 provide various views of another example pet chew toy 120. Pet chew toy 120 is similar to pet chew toy 20 described above in all respects except that pet chew toy 120 has a slightly different aesthetic shape or configuration. Pet chew toy 120 comprises many of the same functional features of pet chew toy 20. As with pet chew toy 20, pet chew toy 120 comprises a core 22 and an outer layer 24 which provide a pet with an enhanced chewing experience, offering enhanced flavor release or exposure to the wood materials of core 22, offering enhanced oral sensation with the texture of core 22, the texture of layer 24 and the texture provided by the asymmetric or irregular overall shape of the pet chew toy and offering enhanced durability a robustness despite the irregular shape. Such features are identified with the same reference numerals.

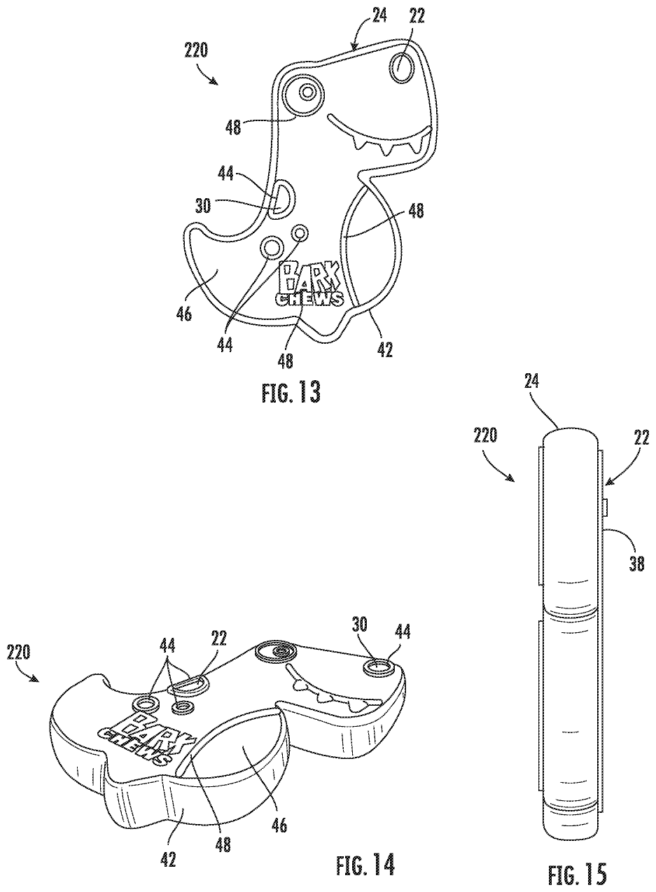

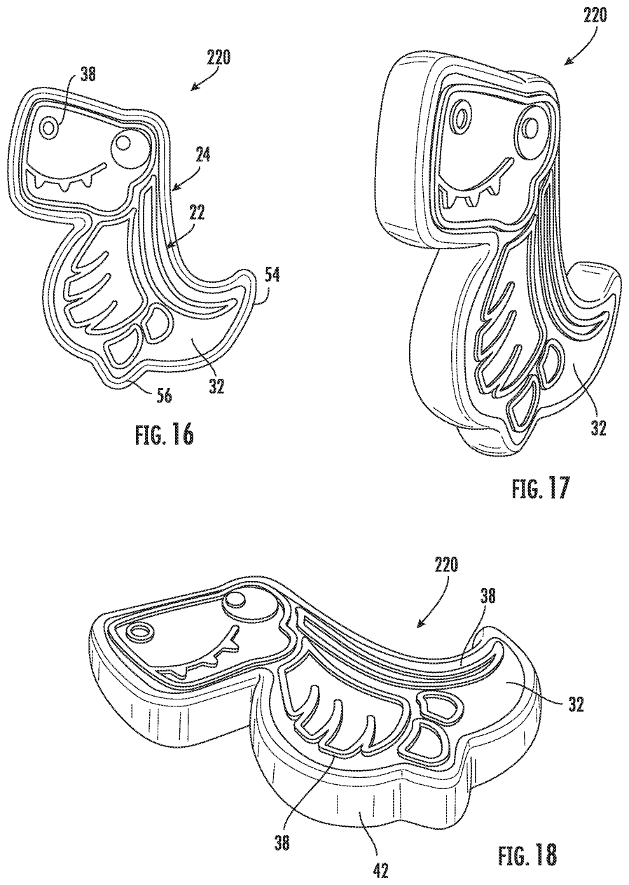

FIGS. 13-18 provide various views of another example pet chew toy 220. Pet chew toy 220 is similar to pet chew toy 20 described above in all respects except that pet chew toy 220 has a slightly different aesthetic shape or configuration. Pet chew toy 220 comprises many of the same functional features of pet chew toy 20. As with pet chew toy 20, pet chew toy 220 comprises a core 22 and an outer layer 24 which provide a pet with an enhanced chewing experience, offering enhanced flavor release or exposure to the wood materials of core 22, offering enhanced oral sensation with the texture of core 22, the texture of layer 24 and the texture provided by the asymmetric or irregular overall shape of the pet chew toy and offering enhanced durability a robustness despite the irregular shape. Such features are identified with the same reference numerals.

Although the present disclosure has been described with reference to example implementations, workers skilled in the art will recognize that changes may be made in form and detail without departing from the spirit and scope of the claimed subject matter. For example, although different example implementations may have been described as including features providing one or more benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A pet chew toy comprising:
a core comprising a mixture of wood and a thermoplastic elastomer; and
a layer of a thermoplastic elastomer partially covering the core.

2. The pet chew toy of claim 1, wherein the core comprises a planar body having a lower face, an upper face and side edges, wherein the layer covers the lower face and the side edges.

3. The pet chew toy of claim 2, wherein the layer comprises openings exposing the lower face of the core.

4. The pet chew toy of claim 3, wherein the layer comprises a three-dimensional image opposite the lower face, facing away from the lower face.

5. The pet chew toy of claim 4, wherein the upper face of the core comprises a three-dimensional image.

6. The pet chew toy of claim 2, wherein the layer comprises a three-dimensional image opposite the lower face, facing away from the lower face.

7. The pet chew toy of claim 6, wherein the upper face of the core comprises a three-dimensional image.

8. The pet chew toy of claim 2, wherein the upper face of the core comprises a three-dimensional image.

9. The pet chew toy of claim 2, wherein the core has a thickness of at least 50 mm and no greater than 70 mm and wherein the layer has a thickness of at least 5 mm and no greater than 10 mm.

10. The pet chew toy of claim 2, wherein the upper face of the core is completely exposed by the layer.

11. The pet chew toy of claim 2, wherein the layer comprises sidewalls extending along the side edges of the core, the sidewalls having an asymmetric shape.

12. The pet chew toy of claim 11, wherein at least one of the upper face of the core and the layer have a three-dimensional image associated with the asymmetric shape of the sidewalls.

13. The pet chew toy of claim 2, wherein the layer forms a floor opposite the lower face of the core and sidewalls along the side edges of the core, wherein the core projects beyond the sidewalls of the layer.

14. The pet chew toy of claim 13, wherein the core comprises:
a main body portion between the sidewalls of the layer and at or below an upper edge of the sidewalls; and
ribs projecting from the main body portion beyond the upper edge of the sidewalls.

15. The pet chew toy of claim 14, wherein the ribs form a three-dimensional image on the upper face of the core.

16. The pet chew toy of claim 1, wherein the mixture comprises at least 20% wood material and at least 70% thermoplastic resin material.

17. The pet chew toy of claim 1, wherein the layer is over molded about portions of the core.

18. A method for forming a pet chew toy, the method comprising:
molding a core from a mixture of a thermoplastic elastomer and wood material, the core being substantially planar, having an upper face, a lower face and side edges; and
overmolding a layer of a thermoplastic elastomer about the lower face and side edges of the core.

19. The method of claim 18, wherein the layer comprises openings exposing the lower face of the core.

20. The method of claim 18, wherein the mixture comprises at least 20% wood material and at least 70% thermoplastic resin material.
